(19) United States
(12) Patent Application Publication
(10) Pub. No.: US 2012/0193037 A1
(43) Pub. Date: Aug. 2, 2012

(54) SHADE ASSEMBLY AND METHOD

(75) Inventor: John Sengelaub, Wantagh, NY (US)

(73) Assignee: Welcome Industrial Corp., Deer Park, NY (US)

(21) Appl. No.: 13/016,166

(22) Filed: Jan. 28, 2011

(51) Int. Cl. A47H 23/04; B23P 11/00; A47H 5/02

(52) U.S. Cl. 160/84.02; 160/84.01; 160/84.04; 29/428

(57) ABSTRACT

A shade assembly includes a first rail, a second rail spaced apart from the first rail, at least one lift cord extending from the first rail to the second rail in a configuration to facilitate selective manipulation of the second rail in a first direction or a second direction relative to the first rail, a shade panel defining a longitudinal axis and being configured to extend axially from the first rail to the second rail in the first direction and fold axially in a bloused arrangement in the second direction, and a liner panel. The liner panel is disposed along the shade panel such that at least a portion of the lift cord is disposed between the liner panel and the shade panel, and is configured to extend axially to the second rail in the first direction and axially fold in a pleated arrangement in the second direction.

### TECHNICAL FIELD

The present disclosure generally relates to window treatments, and more particularly to Roman style window shades equipped with liners.

### BACKGROUND

Individuals occupying a building space including unadorned windows may from time to time wish to have some means of improving the appearance of the windows, blocking sunlight from entering the building space through the window, or preventing others from observing them by peering through the window. Window treatments are well known for covering windows and adjacent areas. Window treatments are available in various devices such as, for example, curtains, drapes, blinds, and shades. These devices can be used in many applications, including use for provision of visual barriers, physical separation, privacy, protection from strong sunlight, and decoration.

Some window coverings incorporate lift cords to raise and lower a shade panel. With the use of such lift cords can come certain design problems. For example, to the extent such lift cords are visible, either to observers occupying the building space within which the window covering is installed, or to observers viewing the window covering through the adjacent architectural feature, the relative attractiveness of the window covering may suffer. In addition, to the extent the design of such window covering is such as to permit an individual (such as an unsupervised child) to gain access to or grasp such a lift cord, and/or to pull at the lift cord sufficiently to form a loop large enough for him or her to pass his head through the loop, safety concerns will arise. This disclosure describes an improvement over these prior art technologies.

### SUMMARY OF THE INVENTION

The present disclosure generally relates to window treatments, and more particularly to Roman style window shades equipped with liners.

In one embodiment, in accordance with the principles of the present disclosure, a shade assembly is provided. The shade assembly includes a first rail, a second rail spaced apart from the first rail, at least one lift cord extending from the first rail to the second rail in a configuration to facilitate selective manipulation of the second rail in a first direction or a second direction relative to the first rail, a shade panel defining a longitudinal axis and being configured to extend axially from the first rail to the second rail in the first direction and fold axially in a bloused arrangement in the second direction, and a liner panel. The liner panel is disposed along the shade panel such that at least a portion of the lift cord is disposed between the liner panel and the shade panel, and is configured to extend axially to the second rail in the first direction and axially fold in a pleated arrangement in the second direction.

In one embodiment, in accordance with the principles of the present disclosure, a method is provided for manufacturing a shade. The method includes providing a first rail, providing a second rail, and providing a shade panel and coupling the shade panel to and between the first rail and the second rail, the shade panel being configured to extend axially as the second rail moves away from the first rail and fold axially in a bloused arrangement as the second rail moves toward the first rail. The method also includes providing a liner panel and positioning the liner panel along the shade panel, the liner panel being configured to extend axially as the second rail moves away from the first rail and fold axially in a pleated arrangement as the second rail moves toward the first rail. The method further includes providing at least one lift cord and coupling the lift cord to and between the first rail and the second rail such that the lift cord is configured to lift the first rail toward the second rail, and such that the material of the liner panel follows a contour of the lift cord as the second rail moves toward the first rail and the liner panel folds axially in the pleated arrangement.

In one embodiment, in accordance with the principles of the present disclosure, a Roman style shade assembly is provided. The Roman style shade assembly includes a head rail, a bottom rail spaced apart from the head rail, at least one lift cord extending from the head rail to the bottom rail in a configuration to facilitate selective manipulation of the bottom rail in a first direction or a second direction relative to the head rail, and a shade panel defining a longitudinal axis and being configured to extend axially from the head rail to the bottom rail in the first direction and fold axially in a bloused arrangement in the second direction. The Roman style shade assembly also includes a liner panel disposed along the shade panel such that at least a portion of the lift cord is disposed between the liner panel and the shade panel. The liner panel includes a plurality of pleats disposed adjacent to the lift cord and is configured to extend axially to the bottom rail in the first direction. The liner panel is operable in the second direction such that each of the pleats of the plurality thereof follows a contour of the lift cord.

### BRIEF DESCRIPTION OF THE DRAWINGS

The present disclosure will become more readily apparent from the specific description accompanied by the following drawings, in which:

FIG. 1 is a side elevational view of one embodiment of a shade assembly in a fully vertically extended configuration in accordance with the principles of the present disclosure;

FIG. 2 is a partial, part cutaway front elevational view of an upper portion of the shade assembly of FIG. 1;

FIG. 3 is a partial side elevational detail view of the upper portion of the shade assembly of FIG. 1;

FIG. 4 is a partial side elevational detail view of a lower portion of the shade assembly of FIG. 1;

FIG. 5 is a side elevational view of the shade assembly of FIG. 1 in a fully vertically retracted configuration;

FIG. 6 is a side elevational view of an embodiment of a shade assembly in a fully vertically extended configuration in accordance with the principles of the present disclosure;

FIG. 7 is a side elevational view of the shade assembly of FIG. 6 in a fully vertically retracted configuration; and

FIG. 8 is a side elevational view of an embodiment of a shade assembly in a fully vertically extended configuration in accordance with the principles of the present disclosure.

Like reference numerals in at least the tens and units digits indicate the same or similar parts throughout the figures.

### DETAILED DESCRIPTION OF THE INVENTION

The present disclosure generally relates to window treatments, and more particularly to Roman style window shades equipped with liners. It is envisioned that the shade assemblies disclosed herein may be operated manually, including either via the use of a free-hanging end portion of a lift cord, or without such a lift cord by means of one or more lifting mechanisms.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, left and right, are for illustrative purposes only and can be varied within the scope of the disclosure. For example, the references “upper” and “lower” are relative and used only in the context to the other, and are not necessarily “superior” and “inferior”.

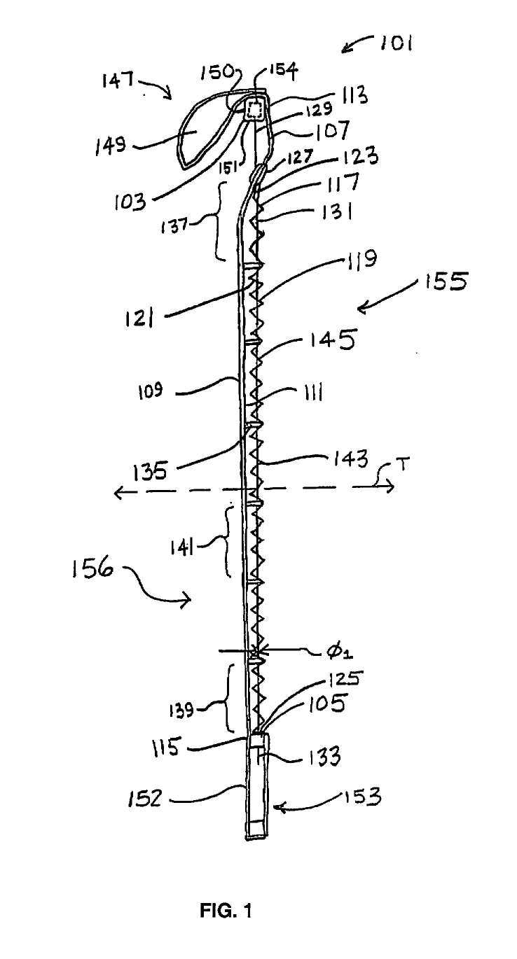

The following discussion includes a description of particular examples of integrated shade assemblies and related methods assembly, modification, and/or upgrade in accordance with the principles of the present disclosure. Alternate embodiments are also disclosed. Reference will now be made in detail to the exemplary embodiments of the present disclosure, which are illustrated in the accompanying figures. Turning now to FIG. 1, a shade assembly 101 in accordance with embodiments of the present disclosure is shown in side elevational view. The shade assembly 101, shown in a fully extended vertical configuration in FIG. 1, includes a head rail 103 extending perpendicular to the paper of FIG. 1, a bottom rail 105 spaced vertically apart from the head rail 103 and extending perpendicular to the paper of FIG. 1 in parallel with the head rail 103, and a shade panel 107 extending perpendicular to the paper of FIG. 1 as well as vertically from the head rail 103 to the bottom rail 105. The shade panel 107 is composed of a fabric material or other textile. The shade panel 107 defines a front surface 109 and a rear surface 111 opposite the front surface 109, and includes an upper margin 113 and a lower margin 115 opposite the upper margin 113. The structure and function of the head rail 103, the bottom rail 105, and the shade panel 107 will be discussed in further detail below.

The shade assembly 101 includes a liner panel 117 extending vertically between the head rail 103 and the bottom rail 105. The liner panel 117 is composed of a fabric material or other textile. The liner panel 117 defines an obverse surface 119 and a reverse surface 121 opposite the obverse surface 119, and includes an upper margin 123 and a lower margin 125 opposite the upper margin 123. The structure and function of the liner panel 117 will be discussed in further detail below.

Each of the head rail 103, the bottom rail 105, the shade panel 107, and the liner panel 117 defines a respective width dimension (not separately shown) extending into the paper of FIG. 1. The head rail 103 is configured and dimensioned for secure mounting along a suitable vertical or horizontal surface in a building space (not separately shown) such as a window, a door, and alcove, and the like. In accordance with embodiments of the present disclosure, one who occupies such building space and observes the shade assembly 101 in the direction of such architectural feature will primarily see the shade panel 107 and will generally not see the liner panel 117, whereas one who is outside such building and observes the shade assembly 101 through the architectural feature will primarily see the liner panel 117 and will generally see the shade panel 105 only partially, if at all. The operation of the shade assembly 101 and its various component parts is discussed in further detail below.

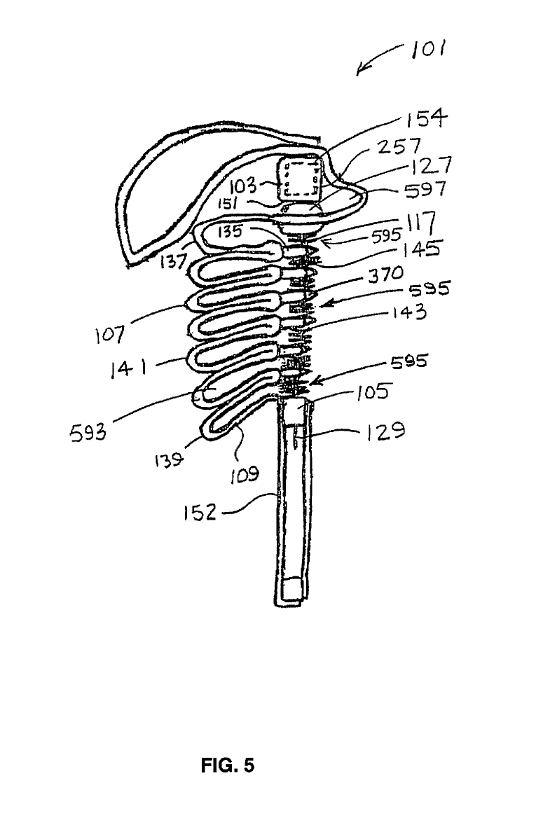

The shade panel 107 is configured to form a so-called Roman style shade. Accordingly, the shade panel 107 is constructed so as to permit it to flex vertically and form loops (such as, for example, as shown in FIG. 5). At any given point along the width dimension of the shade panel 107 however, the shade panel 107 resists transverse or horizontal flexure. The material of the shade panel 107 is thus non-isotropic, in that it allows flexure in one direction but resists flexure in another (e.g., perpendicular) direction. The shade panel 107 may be formed from any appropriate material or combination of materials. For example, the material of the shade panel 107 may include narrow gage, flexible ‘strakes’ such as reeds, split bamboo, faux bamboo, grasses or dowels. In addition, and/or alternatively, plastic elements may be used for such purpose. Such elements may be hollow or solid, such as extruded plastic rods or tubes. Such horizontal elements may be combined to form a fabric, with the strakes arranged in parallel and woven together via fibers extending perpendicularly to and around the fibers. Other embodiments are possible, including embodiments in which one or more portions of the shade assembly 101 in which one or more portions of the shade panel 107 are isotropic, allowing flexure in multiple perpendicular directions.

The upper margin 113 of the shade panel 107 is attached to the head rail 103, and the lower margin 115 of the shade panel 107 is attached to the bottom rail 105. The shade assembly further includes a horizontally arranged series of grommets 127, only one of which is visible in the side elevational view of FIG. 1. The upper margin 123 of the liner panel 117 is attached to the material of the shade panel 107 at least in part by means of the grommets 127. Each of the grommets 127 extends both through the material of the shade panel 107, and through the material of the liner panel 117. The lower margin 125 of the liner panel 117 is attached to the bottom rail 105. The structure and function of the grommets 127 will be discussed in further detail below.

The shade assembly 101 includes a horizontally arranged series of two lift cords 129 having a diameter indicated by ‘ø₁,’ only one of which is visible in the side elevational view of FIG. 1. The lift cord 129 extends vertically between the head rail 103 and the bottom rail 105 in a configuration to facilitate selective manipulation of the bottom rail 105 upward or downward relative to the head rail 103. The lift cord 129 includes a proximal portion 131 disposed adjacent to, and movable in relation to, the head rail 103. The lift cord 129 includes an end portion 133 disposed adjacent to, and securely attached to, the bottom rail 105. The structure and function of the lift cords 129 will be discussed in further detail below. The size and significance of the dimension ø₁ is discussed in further detail below.

The shade assembly 101 includes two vertically arranged series of six rings 135 disposed between the shade panel 107 and the liner panel 117. Only one of the two vertically arranged series of rings 135, consisting of six such rings 135, is visible in the side elevational view of FIG. 1. The rings 135 are disposed adjacent to the rear surface 111 of the shade panel 107, and are securely attached to the material of the shade panel 107. The rings 135 extend transversely or horizontally (which direction is represented by the axis shown in FIG. 1 indicated with the reference letter ‘T’) away from the rear surface 111 of the shade panel 107 toward the reverse surface 121 of the liner panel 117. The rings 135 divide the shade panel 107 into a vertically arranged series of blousing tiers including an uppermost blousing tier 137, a lowermost blousing tier 139, and five intermediate blousing tiers 141. The structure and function of the rings 135 and the blousing tiers 137, 139, 141 will be discussed in further detail below.

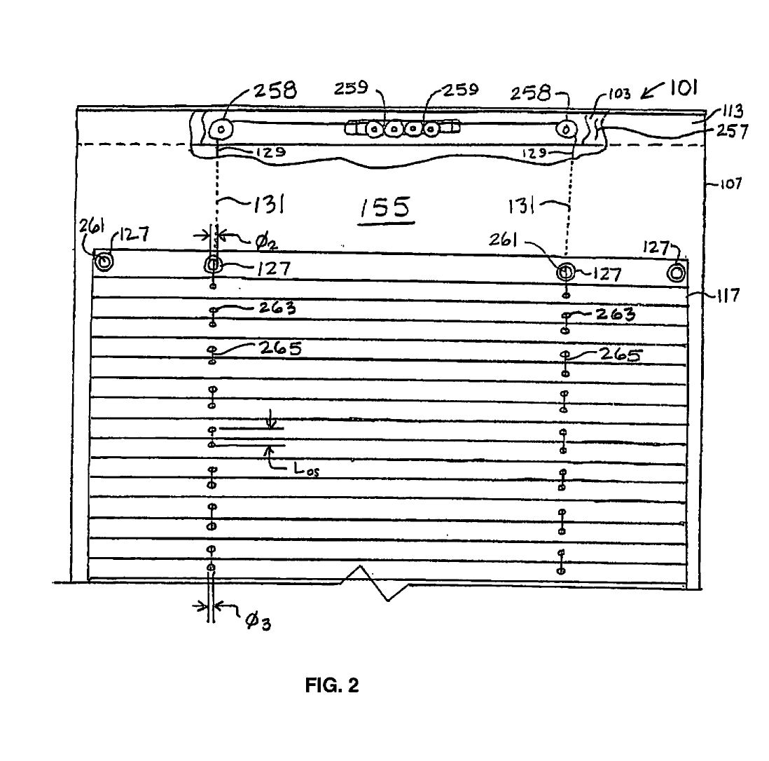

The liner panel 117 includes a vertically arranged series of folds 143 formed in the material of the liner panel 117. The folds 143 divide the liner panel 117 into a corresponding vertically arranged series of pleats 145. Each of the folds 143 and the pleats 145 extends into the paper of FIG. 1 along the entire width dimension of the liner panel 117 (see, for example, FIG. 2). The structure and function of the folds 143 and the pleats 145 of the liner panel 117 will be discussed in further detail below.

The liner panel 117 may be formed from any appropriate material. For example, the liner panel 111 may be formed from a plastic and polycarbonate mix, similar to that used in simple pleat shades. Optional materials for the liner panel 117 may provide sufficient rigidity for the pleats 145 while allowing the liner panel to assume or define permanent folds 143 and retain an accordion-style shape. Alternatively, and/or in addition, one or more of the pleats 145 of the liner panel 117 may be, or form, cellular pleats, including, for example, pleats forming honeycomb cells.

The shade assembly 101 includes a valence 147. The valence 147 is composed of a fabric material or other textile that forms a loop 149 that blouses outward and downward, extending along a front surface 150 of the head rail 105 and past and beneath a lower surface 151 of the head rail 105. The structure and function of the valence 147 will be discussed in further detail below.

The shade assembly 101 includes a skirt 152. The skirt 152 is composed of a fabric material or other textile that extends downward from the bottom rail 105. The structure and function of the skirt 152 will be discussed in further detail below.

The shade assembly 101 includes a stiffening apparatus 153. The stiffening apparatus 153 is coupled to and interoperates with the bottom rail 105 to stiffen the material of the skirt 152. The structure and function of the skirt 152 is discussed in further detail below.

The shade assembly 101 includes a lifting mechanism 154 (obscured) disposed within the head rail 103. The proximal portion 131 of the lift cord 129 is coupled to and interoperates with the lifting mechanism 154 to lift and lower the bottom rail 105 relative to the head rail 103. The structure and function of the lifting mechanism 154 is discussed in further detail below.

Each of the two lift cords 129 of the shade assembly 101 is configured and arranged to extend upward from its connection with the bottom rail 105, pass along (or behind) the rear surface 111 of the shade panel 107 while passing through the six vertically arranged rings 135 and through the pleats 145 of the liner panel 117, continue upward through the corresponding grommet 127 and through the material of the shade panel 107 from the rear surface 111 thereof to the front surface 109 thereof, and continue upward past the lower surface 151 of the head rail 103 and into engagement with the lifting mechanism 154.

The shade assembly 101 includes an exterior side 155. The exterior side 155 of the shade assembly 101 is generally seen by individuals who do not occupy the building space (not shown) within which the shade assembly 101 is mounted, but are located outside of such building space, such that they observe the shade assembly 101 along a line-of-sight that extends through the architectural feature (not shown) adjacent to which the shade assembly 101 is mounted. The structure and function of the exterior side 155 of the shade assembly 101 is discussed in further detail below.

The shade assembly 101 includes an interior side 156. The interior side 156 of the shade assembly is generally seen by individuals who occupy the building space (not shown) within which the shade assembly 101 is mounted, such that they observe the shade assembly 101 directly, rather than through the architectural feature (not shown) adjacent to which the shade assembly 101 is mounted. The structure and function of the interior side 156 of the shade assembly 101 is discussed in further detail below.

As shown in FIG. 1, only at or near the head rail 103 does the proximal portion 131 of the lift cord 129 appear on the interior side 156 of the shade assembly 101. Below that elevation, the proximal portion 131 of the lift cord 129 is alternately enclosed within the shade assembly 101 (extending vertically between the rear surface 111 of the shade panel 107 and the reverse surface 121 of the liner panel 117), or disposed on the external side 155 of the shade assembly 101 (extending vertically along the obverse surface 119 of the liner panel 117). The structural and functional significance of such an arrangement is discussed in further detail below.

Referring now to FIG. 2, an upper portion of the exterior side 155 of the shade assembly 101 is shown in a part cutaway plan elevational view to reveal a portion of the exterior surface of the head rail 103, as well as a portion of the interior of the head rail 103. The head rail 103 includes a rear surface 257. The shade panel 107 is attached to the head rail 103 such that the upper margin 113 of the shade panel 107 extends along the rear surface 257 of the head rail 103, and such that the front surface 109 (see FIG. 1) of the shade panel 107 and the rear surface 257 of the head rail 103 face each other.

The shade assembly 101 includes two separate instances of the lift cord 129 and is configured to allow a user of the shade assembly 101 to manipulate it without having to pull directly on either of the lift cords 129. More particularly, the lifting mechanism 154 includes both a pulley 258 and a spring motor 259 corresponding to each of the two lift cords 129. The pulleys 258 and the spring motors 259 are operatively mounted to the head rail 103. Each pulley 258 is configured and arranged to redirect the proximal portion 131 of the corresponding lift cord 129 horizontally inward toward the corresponding spring motor 259. The lifting mechanism 154 is configured to assist a user in raising the lift cords 129, to receive the proximal portions 131 of the lift cords 129 as the same are fed into the head rail 303 across the respective pulley 258, and to selectably releasably grasp or catch the proximal portions 131 of the lift cords 129 upon the shade assembly 101 reaching the desired vertical position. The spring motors 259 are configured to collect the proximal portions 131 of the lift cords 129 on corresponding spools as the shade assembly 301 is raised, and to generate potential energy as the shade assembly 101 is lowered for later use in lifting same. Additional aspects of the shade assembly 101 relating to the ability of the user to manipulate it without being required to pull directly on either of the lift cords 129 are discussed in further detail below.

The shade assembly includes four separate instances of the grommet 127, each of which defines a corresponding hole 261 having a diameter indicated by ‘ø₂.’ Two instances of the grommet 127 are disposed respectively at the upper left and upper right corners of the liner panel 117 and are used to secure the material of the liner panel 117 to the material of the shade panel 107. Two other instances of the grommet are disposed between the corner-positioned grommets 127 and are used both to secure the material of the liner panel 117 to the material of the shade panel 107, as well as to allow the lift cords 129 to pass through the material of the shade panel 107. The size and significance of the dimension ø₂ is discussed in further detail below.

The grommets 127 may be formed from any suitable material capable of exhibiting: 1) durability and toughness when subjected to repeated use over long periods of time; 2) a smooth surface and/or polished appearance useful for aesthetics as well as for reducing an incidence of wear-producing friction arising from sliding interaction with the lift cords 129; and 3) strength for securely attaching the upper margin 123 of the line panel 117 to the shade panel 107 and withstanding such separation forces as may arise during ordinary use of the shade assembly 101. For example, the grommets 127 may be formed from a metal or metallic material, such as brass, aluminum, or stainless steel. For another example, the grommets 127 may be formed from one or more non-metallic materials, such as plastic or wood.

The liner panel 117 includes two vertically arranged series of perforations 263, each having a diameter indicated by ‘ø₃,’ formed in the material of the liner panel 117 between the obverse surface 119 thereof and the reverse surface 121 thereof. The proximal portion 131 of each of the lift cords 129 is threaded vertically through the material of the liner panel 117, back and forth between the obverse surface 119 thereof and the reverse surface thereof (see FIG. 1), via a corresponding one of the two vertically arranged series of perforations 263. As a result of this arrangement, at any given time, the proximal portion 131 of each of the lift cords 129 may include or exhibit a vertically arranged series of spaced-apart segments 265, each having a length indicated by ‘Lₒₛ,’ extending vertically along the obverse surface 119 of the liner panel 117. The structure, function, and significance of the vertically arranged series of spaced-apart obverse segments 265 of the proximal portions 131 of the lift cords 129 are discussed in further detail below. The size and significance of the respective dimensions ø₃ and Lₒₛ are discussed in further detail below.

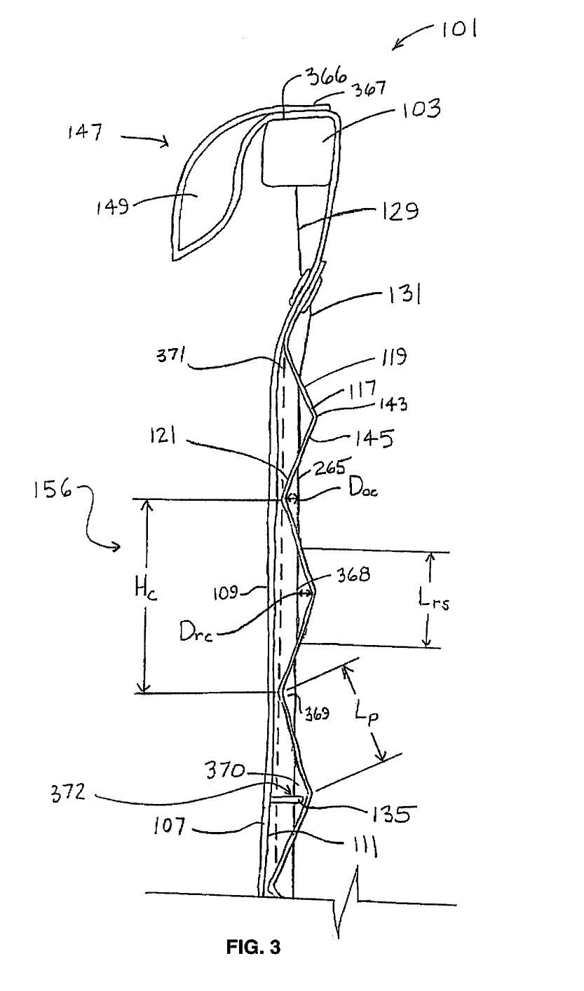

Referring now to FIG. 3, the upper portion of the shade assembly 101 is shown in a side elevational view. The head rail 103 includes an upper surface 366. The material of the valence 147 is an extension of the material of the shade panel 107 and includes a free end portion 367. The valence 147 is attached to the head rail 103 such that the material of the valence 147 extends transversely across the upper surface 366 in the direction of the interior side 156 of the shade assembly, then downward and away from the head rail 103, then upward and back toward the head rail 103 to form the loop 149, where the free end portion 367 of the valence 147 extends transversely back across the upper surface 366 and is secured in place thereat atop the head rail 103. Such an arrangement is advantageous in that from the perspective of one who occupies the building space (not shown) and observes the interior side 155 of the shade assembly 101 directly, the observable surface of the valence 147 has the same appearance as the front surface 109 of the shade panel 107. The significance of the observable surface of the valence 147 having the same appearance as the front surface 109 of the shade panel 107 is discussed in further detail below.

As shown in FIG. 3, and as discussed above, the proximal portion 131 of each of the lift cords 129 is threaded vertically through the material of the liner panel 117, back and forth between the obverse surface 119 thereof and the reverse surface 121 thereof, via a corresponding one of the two vertically arranged series of perforations 263 (see FIG. 2). As a result of this arrangement, at any given time, the proximal portion 131 of each of the lift cords 129 may include or exhibit a vertically arranged series of spaced-apart segments 368, each having a length indicated by ‘Lᵣₛ,’ extending vertically along the reverse surface 121 of the liner panel 117. The size and significance of the dimension Lᵣₛ is discussed further below.

The pleats 145, the folds 143, and the obverse and reverse surfaces 119, 121 of the liner panel 117 cooperate to form or define a vertically arranged series of obverse channels 369 and a vertically arranged series of reverse channels 370. Each of the rings 135 furthermore defines a hole 372 through which the proximate portion 131 of the lift cord 129 may pass. The channels 369, 370 are V-shaped in vertical cross-section as shown in FIG. 3 and prism-shaped when the width dimension of the liner panel 117, extending perpendicular to FIG. 3, is considered. The channels 369, 370 are vertically interleaved with each other, as shown in FIG. 3. In the case of the vertically arranged series of reverse channels 370, the upper-portion of the V-shape terminates at a vertical axis 371 aligned with the folds 143 of the vertical series of folds 143 in the liner panel 117 positioned closest to the shade panel 107.

Each of the obverse channels 369 in the liner panel 117 has a depth indicated by ‘D_{oc}’ representing the distance between the obverse surface 119, measured at the fold 143 at the bottom of the channel 369, and the obverse segment 265 of the lift cord 129. Each of the reverse channels 370 in the liner panel has a depth indicated by ‘D_{rc}’ representing the distance between the reverse surface 121, measured at the fold 143 at the bottom of the channel 370, and the reverse segment 368 of the lift cord 129. Each of the obverse and reverse channels 369, 370 has a height indicated by ‘H_{c}’ representing the vertical distance between the folds 143 forming the opposite horizontal edges of the channel 369, 370. Each of the pleats 145 has a length indicated by ‘Lₚ’ as measured along the material of the liner panel 117 between adjacent folds 143. The size and significance of the respective dimensions D_{oc}, D_{rc}, H_{c}, and Lₚ is discussed in further detail below.

In the case of certain of the reverse channels 370, a ring 135 extending from the rear surface 111 of the shade panel 107 toward the liner panel 117 extends to and beyond the vertical axis 371 and into such reverse channel 370 such the hole 372 formed in the ring 135 is either partially or fully disposed within the prism-shaped area defined by the reverse channel 370. The holes 372 of the rings 135 of the above-described vertically arranged series of six rings 135 (see FIG. 1) are vertically aligned with each other and with the corresponding vertically arranged series of perforations 263 (see FIG. 2) in the pleats 145 of the liner panel 117 such that the corresponding lift cord 129 passes vertically upward through all such holes 372 in the rings 135 and all such perforations 263 (see FIG. 2) in the pleats 145 in its path toward the head rail 103.

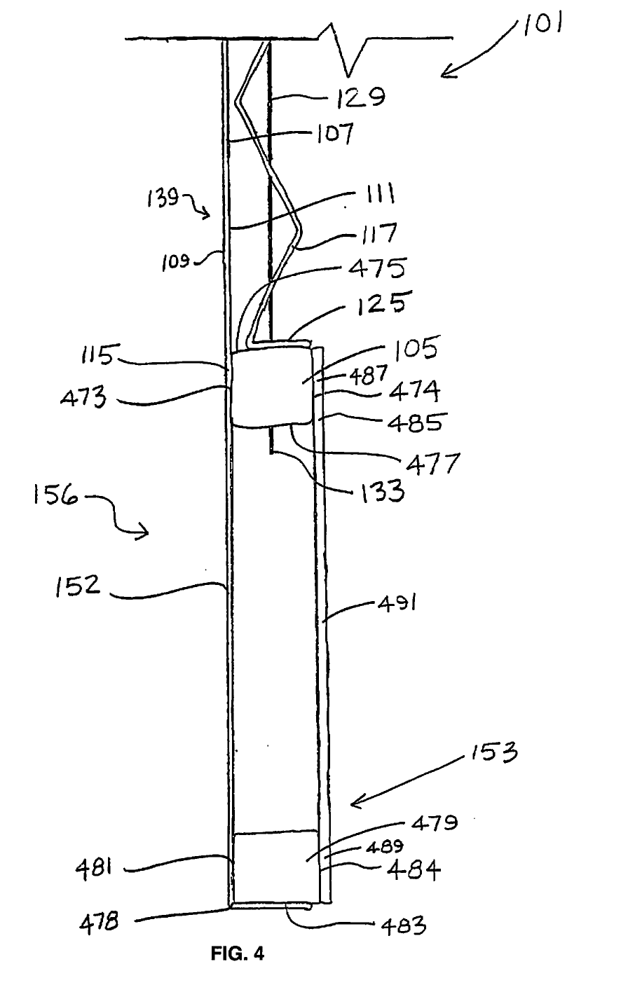

Turning now to FIG. 4, the bottom rail 105 has a front surface 473, a rear surface 474, an upper surface 475, and a lower surface 477.

The shade panel 107 is attached to the bottom rail 105 such that the lower margin 115 of the shade panel 107 extends along the front surface 473 of the bottom rail 105 and the rear surface 111 of the shade panel 107 and the front surface 473 of the bottom rail 105 face each other.

The material of the skirt 152 is an extension of the material of the shade panel 107 and includes a free end portion 478. The skirt 152 is attached to the bottom rail 105 such that the material of the skirt 152 extends vertically downward from the bottom rail 105. Such an arrangement is advantageous in that, from the perspective of one who occupies the building space (not shown) and observes the interior side 156 of the shade assembly 101 directly, no portion of the front surface 109 of the lowermost blousing tier 139 of the shade panel 107 becomes faded over time due to exposure to direct sunlight through the adjacent architectural feature (not shown). The manner in which the skirt 152 blocks direct sunlight from striking the front surface 109 of the lowermost blousing tier 139 of the shade panel 107 is discussed in further detail below.

The stiffening apparatus 153 includes a stiffening rail 479 having a front surface 481, a lower surface 483, and a rear surface 484. The free end portion 478 of the skirt 152 extends to, around, and beneath the stiffening rail 479 and is secured to the front and lower surfaces 481, 483 of the stiffening rail 479.

The stiffening apparatus 153 further includes two instances of a brace 485 having a first end 487, a second end 489 and a spanning length 491 extending between the first end 487 and the second end 489. (One instance of the brace 485 is visible in FIG. 4.) The first end 487 of the brace 485 is secured to the rear surface 474 of the bottom rail 105 and the second end 489 of the brace 485 is secured to the rear surface 484 of the stiffening rail 479. The two instances of the brace 485 cooperate with the stiffening rail 479 and the bottom rail 105 to form a rectangular frame (not fully shown) that serves to stiffen the skirt 152. In addition to improving the durability and overall appearance of the skirt 152, the rectangular frame formed by the braces 485, the stiffening rail 479 and the bottom rail 105 facilitate user manipulation of the shade assembly 101, as is discussed in further detail below.

Attachment between the first end 487 of the brace 485 and the bottom rail 105 and between the second end 489 of the brace 485 and the stiffening rail 479 may be accomplished via any appropriate method. For example, the first end 487 of the brace 485 may be coupled to the bottom rail 105 by means of a selectively releasable clip or clamp (not separately shown) and the second end 489 of the brace 485 may be coupled to the stiffening rail 479 by means of a pivot or hinge (not separately shown) that allows the brace 485 to rotate in one or more planes. Such an arrangement allows the brace 485 to be placed in a retracted or stored position against and along the stiffening rail 479 when necessary or when desired (e.g., in order to prevent the stiffening rail 479 from being used to raise the shade assembly 101), while at the same time allowing the brace 485 and the bottom rail 105 to be reassembled together at any time (e.g., in order to stiffen the skirt 152).

Still referring to FIG. 4, the skirt 152, rather than blousing outwardly, and thereby forming a loop, droop, or sag, upon vertical retraction of the shade assembly 101 (e.g., as is the case with the lowermost blousing tier 139), instead retains its generally vertical orientation regardless of the vertical position or configuration of the shade assembly 101, as is discussed further below with reference to FIG. 5.

Attachment between the lower margin 125 of the liner panel 117 and the bottom rail 105 may be accomplished by any appropriate method. For example, one or more adhesive materials may be used to secure the lower margin 125 of the liner panel 117 to the upper surface 475 of the bottom rail 105, as shown in FIG. 4. Likewise, attachment between the end portion 133 of the lift cord 129 and the bottom rail 105 may be accomplished via any appropriate method. For example, the end portion 133 of the lift cord 129 may be passed through a hole (not shown) formed in the material of the bottom rail 105 (e.g., passing to at least some extent below the lower surface 477 of the bottom rail 105, as shown in FIG. 4), and the end portion 133 may include or form a knot (not shown) to prevent the same from being withdrawn upward from the bottom rail 105 via such hole.

In operation, and referring now to FIGS. 1-5, a user manipulates the lift cords 129 to move the shade assembly 101 from the fully vertically extended configuration thereof shown in FIGS. 1-4 to a fully vertically retracted configuration thereof shown in FIG. 5, thereby raising the shade assembly 101 and exposing the adjacent architectural feature (not shown). For this purpose, the user is assisted by the lifting mechanism 154, as discussed below. By raising the shade assembly 101, the user gathers the material of the shade panel 107, the rings 135, and the material of the liner panel 117 into a relatively compact arrangement adjacent to the head rail 103. The material of the liner panel 117 is gathered in its entirety at or above the elevation of the bottom rail 105.

When the proximate portions 131 of the lift cords 129 and the bottom rail 105 are raised along with the skirt 152, the bottom rail 105 cooperates with the rings 135 and the lift cords 129 to cause the lowermost, intermediate, and finally the uppermost tiers 139, 141, 137 of the shade panel 107 to blouse outward to form respective loops 593 as shown in FIG. 5. At the same time, the folds 143 and perforations 263 formed in the material of the liner panel 117 cooperates with the proximate portions 131 of the lift cords 129 to cause the pleats 145 to collapse toward each other, accordion-style, into a vertically arranged series of compact decks 595 as shown in FIG. 5, thereby eliminating all of the obverse channels 369 and most of the reverse channels 370 which formerly existed between the pleats 145 prior to the shade assembly 101 being raised. One such deck 595 of pleats 145 is formed or disposed between the lowermost ring 135 and the bottom rail 105. Another such deck 595 of pleats 145 is formed or disposed between each adjacent pair of rings 135. A further such deck 595 of pleats 133 is formed or disposed between the uppermost ring 135 and the grommets 127. Certain specific ones of the reverse channels 370 however, though reduced in size, are not eliminated upon the shade assembly 101 assuming the fully vertically retracted configuration shown in FIG. 5, but continue to exist, due to the fact that each such reverse channel 370 continues to be occupied by a corresponding ring 135. In the fully vertically retracted configuration of the shade assembly 101 shown in FIG. 5, the grommet 127 is shown to have been raised upward into contact with the lower surface 151 of the head rail 103. In order to facilitate this, the material of the upper margin 107 of the shade panel 105 may form a small loop 597 adjacent the rear surface 257 of the head rail 103.

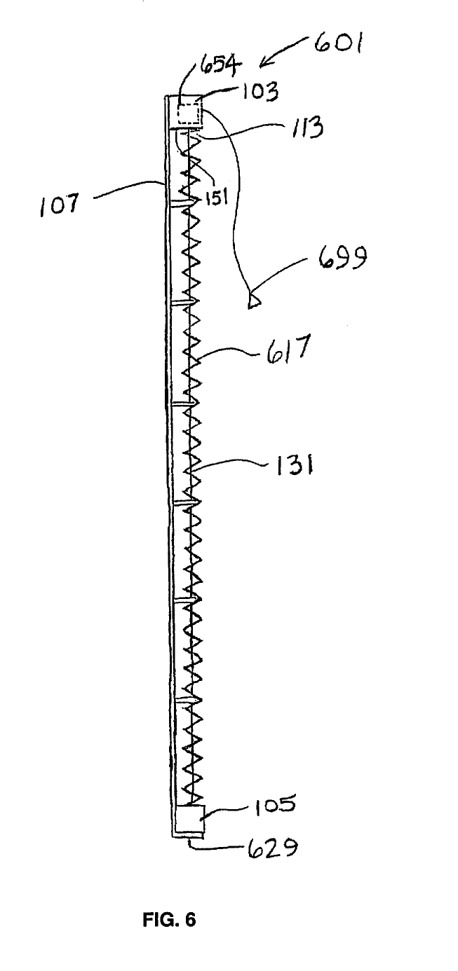

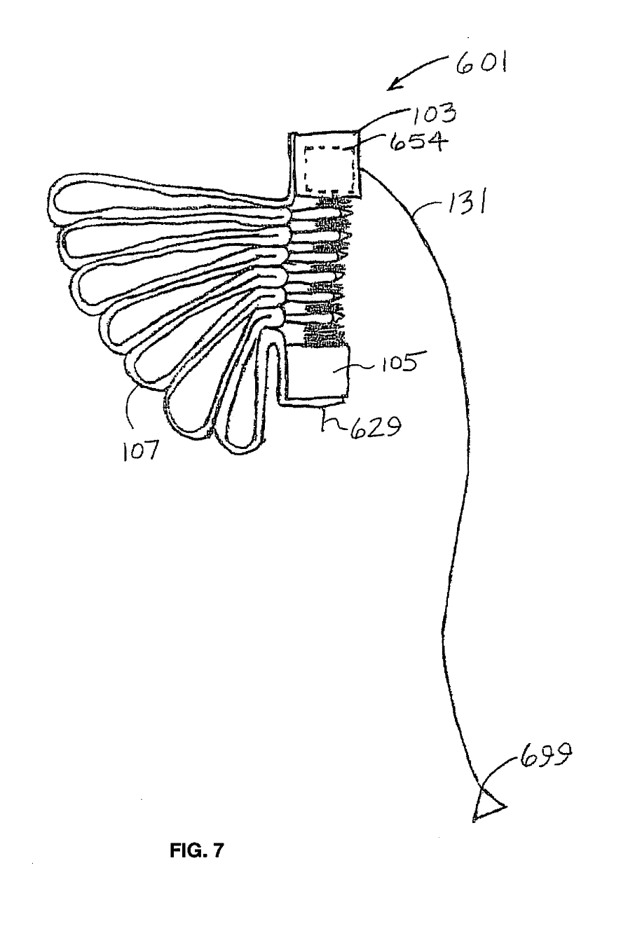

To raise the shade assembly 101, a user pushes the bottom rail 105 or the stiffening rail 479 upward. To lower the shade assembly 101, a user grasps the bottom rail 105 or the stiffening rail 479 and pulls it downward. When raising the shade assembly 101, the user receives assistance via the spring motors 259 pulling or reeling the proximal portions 131 of the lift cords 129 into the head rail 103. When the shade assembly 101 reaches the desired vertical position, the lifting mechanism 154 and/or the spring motors 259 at least temporarily prevent the proximal portions 131 of the lift cords 129 from feeding or reeling outward of the head rail 103. Other mechanisms for raising and lowering the shade assembly 101 may also, or alternatively, be used (such as, for example, as shown in FIGS. 6 and 7).

The shade assembly 101 includes features that enhance its appearance without degrading its functionality. A single vertically continuous extent of flexible fabric is used, not only to form all of the shade panel 107 to provide shade and privacy to the building space (not shown) within which the shade assembly is mounted, but also to form all of the valence 147 and the skirt 152 to obscure from observation by an individual viewing the interior side 156 of the shade assembly 101 from within the building space each of: 1) the head rail 103; 2) the lift cords 129 (e.g., including those portions of the lift cords appearing between the valence 147 and the shade panel 107); 3) the grommets 127 (e.g., in embodiments of the shade assembly 101 in which the valence 147 is large enough to extend below an elevation of the grommets 127); 4) the bottom rail 105; and 5) the stiffening apparatus 153, including the stiffening rail 479 and the braces 485. In addition, the presence of the liner panel 117 along or adjacent the rear surface 111 of the shade panel 107 shields the latter from exposure to direct sunlight, thereby reducing and/or eliminating fading. As shown in FIG. 5, specifically when the lowermost blousing tier 139 of the shade panel is drawn up in a loop 593, the presence of the skirt 152 shields the front surface 109 of the liner panel 117 within the lowermost blousing tier 139 from exposure to direct sunlight, thereby reducing and/or eliminating fading. Also, the stiffening rail 479 and the braces 485 may be formed from plastic, the color of which may be designed to match any one or more, or each, of the color of the rear surface 111 of the shade panel 107, the color of the bottom rail 105, and the color of the skirt 152. This improves the appearance of the exterior side 156 of the shade assembly 101 by avoiding undue contrast between the color and structure of the stiffening apparatus 153 on the one hand, and the bottom rail 105, the shade panel 107, and the skirt 152 on the other. As a result, in at least some embodiments, no woven backing is needed to obscure the stiffening apparatus 153 from the view of individuals observing the exterior side 156 of the shade assembly 101 from outside the building space (not shown).

The shade assembly 101 has the advantage of being aesthetically pleasing while at the same time being functionally advanced. The liner panel 117 improves the appearance of the exterior side 156 of the shade assembly 101 when the latter is partially or fully vertically extended. In the absence of the liner panel 117, individuals observing the shade assembly 101 from outside the building space (not shown) would see an exterior side of the shade assembly 101, the features of which would appear substantially utilitarian, in that the appearance of such features would stem largely from their function. More particularly, such individuals would likely have a full view of most if not all of the rings 135 attached to the material of the shade panel 107 and extending therefrom to interact with the proximal portions 131 of the lift cords 129. Due to the presence of the liner panel 117 forming part of the exterior side 156 of the shade assembly 101, and being at least vertically coextensive with the shade panel 107, however, all of the rings 135 are obscured from view, together with a substantial portion of the proximal portions 131 of the lift cords 129. In addition, to the extent portions of the proximal portions 131 of the lift cords 129 remain visible to such externally-positioned individuals, such structure (e.g., the obverse segments 265 of the proximal portions 131 of the lift cords), rather than having a loose and therefore disorderly and distracting appearance, instead have an orderly, gathered appearance not dissimilar in appearance to that of the lift cords of conventional window shades in which the primary shade panel itself has a pleated appearance.

Still referring to FIGS. 1-5, the liner panel 117 of the shade assembly 101 also functions to improve product safety. In one particular example of the shade assembly 101, the following numerical values apply to the dimensions of corresponding structure discussed above: Lₚ=1 inch (2.54 cm); Lₒₛ=1 inch (2.54 cm); Lᵣₛ=1 inch (2.54 cm); D_{oc}=0.25 inch (0.64 cm); D_{rc}=0.25 inch (0.64 cm); ø₁=0.1 inch (0.25 cm); ø₂=0.5 inch (1.27 cm); ø₃=0.25 inch (0.64 cm); H_{c}=1.75 inch (4.45 cm); the material of the lift cord 129 is nylon; the material of the pleats 145 of the liner panel 117 is a polyvinyl chloride (PVC)/polycarbonate mix (a plastic material that in ordinary use tends to retain its shape better than cloth); and the material of the shade panel 107 is, or at least includes, bamboo. The lift cord 129 may alternatively be made of cotton, and the pleats 145 may alternatively be made of cloth. In embodiments of the present disclosure, any or each of these dimensions and/or materials may vary according to the particular application, and/or as desired. Referring most particularly to FIG. 2, to the extent portions (e.g., the obverse segments 265) of the proximal portions 131 of the lift cords 129 remain visible to and accessible by an individual located inside the building space (e.g., an unsupervised child who has managed to position himself or herself between the shade assembly 101 and the adjacent architectural feature (not shown), such structure, rather than being loose and susceptible to the formation of dangerously large loops (see below discussion of “hazardous loops”), is instead neatly collected closely adjacent to the obverse surface 119 or the reverse surface 121 of the liner panel 117 in short lengths long enough only to span the short distance between two adjacent pleats 145.

The American National Standards Institute (ANSI) Window Covering Manufacturers Association (WCMA) standard ANSI/WCMA A100.1-2010 (PS2) Revision of Provisional ANSI/WCMA A100.1-2009 (referred to herein as the ANSI/WCMA A100.1 standard) is concerned with the safety of (among other types of shades) Roman style shades, and more particularly with hazardous loops or openings that may be created between the lift cord and shade material of such shades. According to the ANSI/WCMA A100.1 standard, the term “hazardous loop” is defined as follows: “With reference to Roman style shades . . . , a combined loop that can be formed on a properly installed window covering product by reasonable foreseeable manipulation of the accessible cord by the ability of young children that would be large enough to fit over their head to create a strangulation hazard. Loops that are formed by excessive or intricate manipulations, including damaging the product or using tools, of the accessible cord shall be considered as exempt.” In order for a Roman style shade having accessible inner cords to meet the safety requirements of the ANSI/WCMA A100.1 standard, it must meet the test requirements of Appendix D (Roman Style Shade Accessible Lift Cord Test Procedure), preventing a hazardous loop from forming. The shade assembly 101 qualifies as a Roman style shade having accessible inner cords according to the ANSI/WCMA A100.1 standard. According to section 6.6.1 of the ANSI/WCMA A100.1 standard, the maximum loop created by a perpendicular pull force of 10 lbF (32 N) applied to the proximal portion 131 of the lift cord 129 above the bottom rail 105 when the shade assembly 101 is fully lowered shall be no more than six (6) inches (152 mm) long, equivalent to a four (4) inch (102 mm) diameter loop. The present applicant tested the example of the shade assembly 101 having the above-described dimensions and materials in the manner required by test procedure D3, “Creation of a Hazardous Loop,” of the ANSI/WCMA A100.1 standard and found that no loop or opening large enough to be considered a hazardous loop as defined in section 6.6.1 existed or could be formed. Accordingly, the shade assembly 101 meets the ANSI/WCMA A100.1 requirements for covered products (described in section 1.3 of the ANSI/WCMA A100.1 standard to include cellular shades, horizontal blinds, pleated shades, roll-up blinds, roller shades, Roman style shades, traverse rods, and vertical blinds, and stock and custom products) that reduce the possibility of injury, including strangulation, to young children from the bead chain, cord, or any type of flexible loop device used to operate the product.

FIGS. 1-5 show that the shade assembly 101 includes a valence 147. It is contemplated that the shade assembly 101 may include no such valence (such as, for example, is shown in FIGS. 6 and 7).

FIGS. 1-5 show that the shade assembly 101 includes a skirt 152 and a stiffening apparatus 153 employable to stiffen the skirt 152. It is contemplated that the shade assembly 101 may include no such skirt or stiffening apparatus (such as, for example, is shown in FIGS. 6 and 7).

FIGS. 1-5 show that the upper margin 123 of the liner panel 117 is secured directly to the material of the shade panel 107. It is contemplated that the upper margin 123 of the liner panel 117 may be spaced apart from the shade panel 107 and/or secured only indirectly to the shade panel 107 (such as, for example, is shown in FIGS. 6 and 7).

FIGS. 1-5 show that the proximal portions 131 of the lift cords 129 extend along the front surface 109 of the shade panel 107 as well as the rear surface 111 thereof. It is contemplated that the proximal portions 131 of the lift cords 129 may extend along only along the rear surface 111 of the shade panel 107 (such as, for example, is shown in FIGS. 6 and 7).

FIGS. 1-5 show that the shade assembly 101 includes a lifting mechanism 154 configured and equipped to assist a user in raising or lowering the bottom rail 105 relative to the head rail 103 without the need for direct manual manipulation of the lift cords 129. It is contemplated that the lifting mechanism 154 may be eliminated, or modified to include less functionality, and that the lift cords 129 may include additional end portions extending from the head rail 103 to enable a user to raise or lower the bottom rail 105 relative to the head rail 103 via direct manual manipulation of the lift cords 129 (such as, for example, as is shown in FIGS. 6 and 7). Other configurations are possible, including configurations in which the lifting mechanism 154 includes additional functionality, including, for example, an electric motor for raising and/or lowering the bottom rail 105 relative to the head rail 103, and/or a remote control feature allowing a user to raise and/or lower the bottom rail 105 relative to the head rail 103 by means of a hand-held remote control device or a wall-mounted switch/controller.

FIGS. 1-5 show the ratio of the length Lₒₛ of the obverse segments 265 to the length Lᵣₛ of the reverse segments 368 to be approximately one-to-one (1:1). It is contemplated that the ratio of the length Lₒₛ of the obverse segments 265 to the length Lᵣₛ of the reverse segments 368 may be other than approximately one-to-one (1:1).

FIGS. 1-5 show the ratio of the depth D_{oc} of the obverse channels 369 (i.e., beneath the adjacent obverse segment 265) to the depth D_{rc} of the reverse channels 370 (i.e., beneath the adjacent reverse segment 368) to be approximately one-to-one (1:1). It is contemplated that the ratio of the depth D_{oc} of the obverse channels 369 to the depth D_{rc} of the reverse channels 370 may be other than approximately one-to-one (1:1).

In the shade assembly 101 shown and described with reference to FIGS. 1-5, the ratio of the diameter ø₁ of the lift cord 129 to the diameter ø₂ of the holes 261 in the grommets 127 is approximately 0.16:1. It is contemplated that the ratio of the diameter ø₁ of the lift cord 129 to the diameter ø₂ of the holes 261 in the grommets 127 may be other than approximately 0.16:1.

In the shade assembly 101 shown and described with reference to FIGS. 1-5, the ratio of the diameter ø₁ of the lift cord 129 to the diameter ø₃ of the perforations 263 is approximately 0.33:1. It is contemplated that the ratio of the diameter ø₁ of the lift cord 129 to the diameter ø₃ of the perforations 263 may be other than approximately 0.33:1.

In the shade assembly 101 shown and described with reference to FIGS. 1-5, the diameter of the holes 372 in the rings 135 is 0.5 inch (1.27 cm). In embodiments of the present disclosure, this dimension may vary according to the particular application, and/or as desired. The ratio of the diameter ø₁ of the lift cord 129 to the diameter (not specifically indicated) of the holes 372 in the rings 135 is approximately 0.16:1. It is contemplated that the ratio of the diameter ø₁ of the lift cord 129 to the diameter of the holes 372 in the rings 135 may be other than approximately 0.16:1.

In the shade assembly 101 shown and described with reference to FIGS. 1-5, the ratio of the length Lₚ of the pleats 145 to the height H_{c} of the channels 369, 370 between adjacent folds 143 when the shade assembly 101 is fully vertically extended is approximately 0.57:1. It is contemplated that the ratio of the length Lₚ of the pleats 145 to the height H_{c} of the channels 369, 370 between adjacent folds 143 when the shade assembly 101 is fully vertically extended may be other than approximately 0.57:1.

In the shade assembly 101 shown and described with reference to FIGS. 1-5, various combinations of materials, in addition to those discussed above, for use in the lift cords 129, in the grommets 127, in the rings 135, and in the pleats 145 of the liner panel 117 are possible, translating to various degrees of roughness or smoothness in the materials used, various degrees of friction generated between components of the shade assembly 101 configured to have a sliding relationship with each other, and/or various degrees of difficulty in forming loops or openings that are potentially hazardous to small children (see below discussion relating to the latter concern).

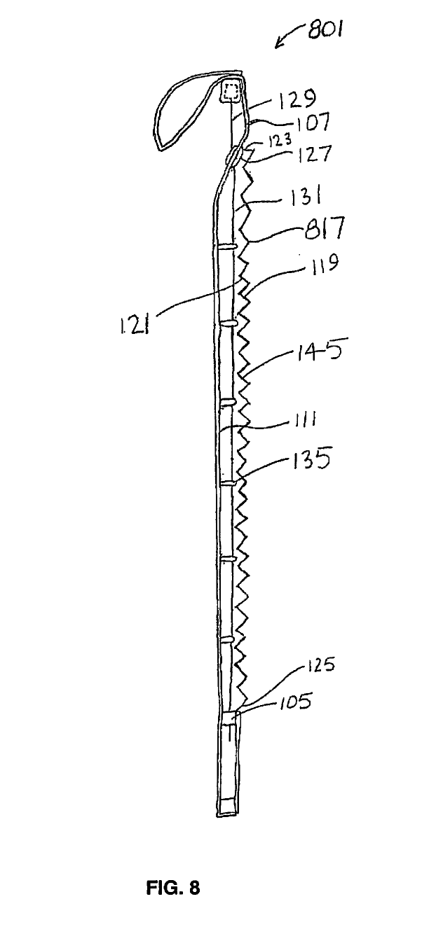

FIGS. 1-5 show that in extending from the bottom rail 105 to the head rail 103, the proximal portions 131 of the lift cords 129 extend along both the reverse surface 121 of the liner panel 117 (e.g., see the reverse segments 368 of the lift cords 129) and the obverse surface 119 of the liner panel 117 (e.g., see the obverse segments 265 of the lift cords 129). Other configurations are possible, including configurations (such as, for example, as is shown in FIG. 8) in which, to the extent the proximal portions 131 of the lift cords 1229 above the bottom rail 105 are disposed on the side of the shade panel 107 corresponding to the rear surface 111 of the shade panel 107, the lift cords 129 are fully and completely enclosed within the shade assembly 101 between the rear surface 111 of the shade panel 107 and the reverse surface 121 of the liner panel 117.

In one embodiment in accordance with the principles of the present disclosure, a method of manufacturing a Roman style shade (not separately shown) is provided. In accordance with at least some such embodiments, the method includes a step in which the lift cords of a Roman style shade are detached from the bottom rail, a step in which an instance of the liner panel 117 is incorporated into the Roman style shade at least in part by threading the lift cords of the Roman style shade through the perforations 263 of the liner panel 117, and a step in which the lift cords are re-attached to the bottom rail. In accordance with such embodiment, the Roman style shade may be a previously assembled shade being modified to include the liner panel 117.

Other assembly steps are possible. For example, the upper margin 123 of the liner panel 117 may be attached to the head rail of the Roman style shade (see, for example, FIG. 6), or may be secured directly to the material of the shade panel of the Roman style shade together (see, for example, FIG. 3).

The method may be modified to eliminate the step in which the lift cords of a Roman style shade are detached from the bottom rail. For example, in one embodiment, the Roman style shade is not a previously assembled Roman style shade, but rather is a Roman style shade (not separately shown) being fabricated in the first instance from various components including a head rail, a bottom rail, lift cords, and the liner panel 117.

In one embodiment, as shown in FIGS. 6 and 7, a shade assembly 601, similar to the shade assembly 101 described above, has no valence, no skirt, and no stiffening apparatus for stiffening the skirt.

Rather than being directly secured to the material of the shade panel 107, the upper margin 113 of the liner panel 617 is attached to the lower surface 151 of the head rail 103. Attachment between the upper margin 113 of the liner panel 617 and the head rail 103 may be accomplished by any appropriate method. For example, one or more adhesive materials may be used to secure the upper margin 113 of the finer panel 617 to the lower surface 151 of the head rail 103. In accordance with the embodiment of FIGS. 6 and 7, the liner panel 617 is vertically coextensive with the shade panel 107.

The lifting mechanism 654 of the shade assembly 601 differs from the lifting mechanism 154 of the shade assembly 101 (FIG. 1) in that it includes no spring motor and no spools to gather the proximal portion 131 of the lift cord 629. The proximal portion 131 of the lift cord 629 is not collected in the head rail 103 as the bottom rail 105 is raised toward the head rail 103, but is fed both through and outward of the head rail 103, terminating in another end portion 699 disposed opposite the end portion 133. In operation, a user grasps the end portion 699 and directly manipulates the lift cord 629 to raise and lower the bottom rail 105 relative to the head rail 103.

In one embodiment, as shown in FIG. 8, a shade assembly 801, similar to the shade assembly 101 described above, is configured such that, to the extent the proximal portions 131 of the lift cords 129 above the bottom rail 105 are disposed on the side of the shade panel 107 corresponding to the rear surface 111 of the shade panel 107, the lift cords 129 are fully and completely enclosed within the shade assembly 801.

Rather than including perforations through the material of the pleats 145 of the liner panel 817 through which the proximal portions 131 of the lift cords 129 pass, the liner panel 817 includes no such perforations. Between the bottom rail 105 and the grommets 127, the proximal portions 131 of the lift cords 129 are fully and completely enclosed within the shade assembly 801 between the rear surface 111 of the shade panel 107 and the reverse surface 121 of the liner panel 817. The upper margin 123 of the liner panel 817 is secured to the material of the shade panel 107 via the grommets 127 such that the obverse surface 119 of the liner panel 817 is folded over and held in intimate communication with the rear surface 111 of the shade panel 107 by the grommets 127. Other fastening means, such as an appropriate adhesive, may also be used. The lower margin 125 of the liner panel 817 is secured to the bottom rail 105 in a similar manner as discussed above with respect to the shade assembly 101 of FIG. 1. Other connections may be formed in addition to the connections formed at the upper margin 123 and lower margin 125 of the liner panel 817. For example, one or more of the left and right side margins (not separately shown or indicated) of the liner panel 817 may be connected, directly or indirectly, to the material of the shade panel 107 (connections not separately shown) by any conventional means suitable for such purpose. For another example, one or more of the pleats 145 of the liner panel 817 may be connected, directly or indirectly, to one or more of the rings 135, and/or to the proximal portions 131 of the lift cords 129, by any conventional means suitable for such purpose.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A shade assembly, comprising:
a first rail;
a second rail spaced apart from the first rail;
at least one lift cord extending from the first rail to the second rail in a configuration to facilitate selective manipulation of the second rail in a first direction or a second direction relative to the first rail;
a shade panel defining a longitudinal axis and being configured to extend axially from the first rail to the second rail in the first direction and fold axially in a bloused arrangement in the second direction; and
a liner panel disposed along the shade panel such that at least a portion of the lift cord is disposed between the liner panel and the shade panel, the liner panel being configured to extend axially to the second rail in the first direction and axially fold in a pleated arrangement in the second direction.

2. A shade assembly as recited in claim 1, wherein the liner panel includes a plurality of pleats and a corresponding plurality of fold lines formed in the material of the liner panel between the pleats of the plurality thereof, the liner panel being configured such that at least some of the pleats of the plurality thereof fully collapse against each other in the second direction to form one or more decks of pleats.

3. A shade assembly as recited in claim 1, wherein the liner panel and the lift cord cooperate to provide that the maximum loop created by a perpendicular pull of 10 lbF (32 N) applied to the lift cord above the second rail when the shade assembly is fully lowered is no more than six (6) inches (152 mm) long or four (4) inches (102 mm) in diameter.

4. A shade assembly as recited in claim 1, wherein the lift cord extends through a plurality of perforations arranged in a vertical series and formed in the material of the liner panel.

5. A shade assembly as recited in claim 1, wherein the lift cord extends through at least one perforation formed in the material of the shade panel.

6. A shade assembly as recited in claim 1, wherein the shade panel includes a front surface facing away from the liner panel and a rear surface opposite the front surface and facing toward the liner panel, at least a portion of the lift cord extends vertically upward from the bottom rail along a side of the shade panel corresponding to the rear surface thereof, and to the extent the lift cord extends vertically upward from the bottom rail along the side of the shade panel corresponding to the rear surface, the lift cord is disposed fully and completely within the shade assembly between the rear surface of the shade panel and the liner panel.

7. A shade assembly as recited in claim 1, wherein the liner panel is operable in the second direction such that all of the material of the liner panel gathers at or above an elevation of the bottom rail, and no portion of the material of the liner panel extends therebelow.

8. A shade assembly as recited in claim 1, wherein the liner panel includes a plurality of pleats disposed adjacent to the lift cord and is operable in the second direction such that each of the pleats of the plurality thereof follows a contour of the lift cord in the second direction.

9. A shade assembly as recited in claim 1, wherein an upper margin of the material of the liner panel is directly attached to the material of the liner panel.

10. A shade assembly as recited in claim 1, further comprising a lifting mechanism operatively coupled to the first rail, the lifting mechanism including a spring motor configured to collect the lift cord as the second rail moves in the second direction relative to the first rail, thereby assisting a user in manipulating the shade assembly.

11. A shade assembly as recited in claim 1, further comprising a plurality of rings coupled to the material of the shade panel, extending from the shade panel toward the liner panel, and protruding into a corresponding plurality of channels formed by the material of the liner panel, where each ring of the plurality thereof defines a loop through which the lift cord extends.

12. A shade assembly as recited in claim 11, wherein the liner panel operates to shield each ring of the plurality thereof from view by individuals observing the shade assembly from in front of the liner panel.

13. A Roman style shade assembly, comprising:
a head rail;
a bottom rail spaced apart from the head rail;
at least one lift cord extending from the head rail to the bottom rail in a configuration to facilitate selective manipulation of the bottom rail in a first direction or a second direction relative to the head rail;
a shade panel defining a longitudinal axis and being configured to extend axially from the head rail to the bottom rail in the first direction and fold axially in a bloused arrangement in the second direction; and
a liner panel disposed along the shade panel such that at least a portion of the lift cord is disposed between the liner panel and the shade panel, the liner panel including a plurality of pleats disposed adjacent to the lift cord, the liner panel being configured to extend axially to the bottom rail in the first direction, and being operable in the second direction such that each of the pleats of the plurality thereof follows a contour of the lift cord.

14. A shade assembly as recited in claim 13, wherein the liner panel and the lift cord cooperate to provide that the maximum loop created by a perpendicular pull of 10 lbF (32 N) applied to the lift cord above the second rail when the shade assembly is fully lowered is no more than six (6) inches (152 mm) long or four (4) inches (102 mm) in diameter.

15. A shade assembly as recited in claim 13, wherein the lift cord extends through a plurality of perforations formed in the pleats of the plurality thereof.

16. A shade assembly as recited in claim 13, wherein an upper margin of the material of the liner panel is directly attached to the material of the liner panel.

17. A shade assembly as recited in claim 13, further comprising a plurality of rings coupled to the material of the shade panel, extending from the shade panel toward the liner panel, and protruding into a corresponding plurality of channels formed by the pleats of the plurality thereof, where each ring of the plurality thereof defines a loop through which the lift cord extends.

18. A shade assembly as recited in claim 17, wherein the liner panel operates to shield each ring of the plurality thereof from view by individuals observing the shade assembly from in front of the liner panel.

19. A method for manufacturing a shade, the method comprising:
providing a first rail;
providing a second rail;
providing a shade panel and coupling the shade panel to and between the first rail and the second rail, the shade panel being configured to extend axially as the second rail moves away from the first rail and fold axially in a bloused arrangement as the second rail moves toward the first rail;
providing a liner panel and positioning the liner panel along the shade panel, the liner panel being configured to extend axially as the second rail moves away from the first rail and fold axially in a pleated arrangement as the second rail moves toward the first rail; and
providing at least one lift cord and coupling the lift cord to and between the first rail and the second rail such that the lift cord is configured to lift the first rail toward the second rail, and such that the material of the liner panel follows a contour of the lift cord as the second rail moves toward the first rail and the liner panel folds axially in the pleated arrangement.

20. A method as recited in claim 19, wherein the step of positioning the liner panel along the shade panel includes threading the lift cord through the material of the liner panel.

21. A method as recited in claim 20, wherein the liner panel includes a plurality of pleats, and the step of positioning the liner panel along the shade panel includes threading the lift cord through perforations formed in the pleats of the plurality thereof of the liner panel.

22. A method as recited in claim 20, wherein the shade panel includes a front surface facing away from the liner panel and a rear surface opposite the front surface and facing toward the liner panel, at least a portion of the lift cord extends vertically upward from the first rail along a side of the shade panel corresponding to the rear surface thereof, and to the extent the lift cord extends vertically upward from the first rail along the side of the shade panel corresponding to the rear surface, the lift cord is disposed fully and completely within the shade assembly between the rear surface of the shade panel and the liner panel.
